(19) United States
(12) Patent Application Publication
(10) Pub. No.: US 2026/0119986 A1
(43) Pub. Date: Apr. 30, 2026

(54) PATH TRAJECTORY FUNCTIONAL ENCRYPTION

(71) Applicant: LENOVO (BEIJING) LIMITED, Morrisville, NC (US)

(72) Inventors: Chunling Han, Changping District, Beijing (CN); Igor Stolbikov, Apex, NC (US); Scott Li, Cary, NC (US); Christian De Hoyos, Morrisville, NC (US)

(21) Appl. No.: 19/118,735

(22) PCT Filed: Oct. 4, 2022
(86) PCT No.: PCT/CN2022/123707

§ 371 Date: Apr. 4, 2025

(51) Int. Cl. G06N 20/00; G05D 1/646; G06F 18/214

(52) U.S. Cl. CPC G06N 20/00; G05D 1/646; G06F 18/214

(57) ABSTRACT

A system to determine path trajectory using functional encryption receives training data relating to the path trajectory (610), and functionally encrypts the training data, thereby creating first function values that comprise no private user data (620). The system extracts features from the first function values (630), and uses the features to train a machine learning algorithm (640). The system then receives test data relating to the path trajectory (650), and functionally encrypts the test data, thereby creating second function values that comprise no private user data (660). The system provides the second function values to the trained machine learning algorithm (670), and provides a prediction or a decision relating to the path trajectory based on the second function values.

### TECHNICAL FIELD

Embodiments described herein generally relate to using functional encryption in determining path trajectories such that users′ private data are protected.

### BACKGROUND

Machine learning is well known as a tool of artificial intelligence, and it has been widely used in people's daily lives. More and more people are using machine learning tools unconsciously every day, such as map apps, online shopping, social media and even selfie cameras. However, with the growing concern over data privacy, people are worried about the privacy of their data that are learned by machine learning models.

For example, when using map apps, people's locations and driving trajectories are collected and learned by map service servers. These data are used to train machine learning models to provide better service. Consequently, map apps learn over time where people live and work. However, locations and driving trajectories are very sensitive data, and the collection of these sensitive data causes concern.

Prior attempts to solve this problem are based on secure two-party or multiparty computation, homomorphic encryption and other randomized or anonymous methods. However, the use of secure multiparty computation in machine learning is very inefficient, especially when it involves big data. The numerous computational tasks that are required for these prior attempts reduce the efficiency of machine learning. When randomization or anonymization is used, data privacy is protected by removing identifiers such as names and ages, or by adding some noise to the private data. However, the remaining data can be combined with some extra data, and this combination can possibly be used to re-identify individuals.

As noted above, cryptography may be a candidate to provide protection of confidentiality and privacy by encrypting sensitive data before uploading (to a cloud driving app for example). Advances in cryptography provide operations on encrypted data including searching and computation, such as homomorphic encryption. With advances in fully homomorphic encryption (FHE), a well-designed FHE can theoretically provide data privacy. However, though homomorphic encryption is one of the best candidates for privacy-preserving machine learning over encrypted data, there still are some inherent limitations, such as FHE can only conduct computations, but it cannot offer decisions. If data are encrypted using FHE, anyone can evaluate the data with the knowledge of a public key. However, only the holder of a secret key can decrypt the result of the evaluation and the ciphertexts. And while FHE has many applications in outsource computation, it eliminates many application scenarios in which a user needs to make decisions relating to the results of the computation.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a system and method to use functional encryption in a path trajectory system.

FIG. 2 illustrates a path trajectory from a source, through intermediate points, to a destination.

FIG. 3 illustrates a first function of features and a second function of features associated with a path trajectory.

FIG. 4 illustrates a system and method that uses traditional deep learning in determining a path trajectory.

FIG. 5 illustrates a system and method that uses functional encryption in connection with deep learning in determining a path trajectory.

FIG. 6 is a block diagram illustrating operations and features of a system and method of using functional encryption and deep learning in determining path trajectories.

FIG. 7 is a block diagram of a computer architecture that can be used in connection with one or more embodiments of the current disclosure.

### DETAILED DESCRIPTION

An embodiment of the present disclosure uses a functional encryption scheme to determine path trajectories while at the same time protecting the privacy of user data. As is known in the art, with functional encryption, a machine learning algorithm and server can only obtain function values of original user data, not the actual user data. With functional encryption, one can allow others to learn a function value of a plaintext directly from the ciphertext, but nothing else.

By using functional encryption, unlike with most privacy-preserving machine learning methods in which the classification and decision need to be decrypted and made by users, embodiments of the present disclosure permit the machine learning model to make decisions on its own without disclosing the original data. For example, in a particular embodiment involving a map service, the map service can be trained on and learn with encrypted driving trajectories, and the service can then give predictions to users directly.

Functional encryption provides excellent properties for outsource computations, detections, predictions and many other cloud services. A user can delegate a functional key to the machine learning server, and the server can gain a function value of the user's plaintexts, but nothing else. In a map service embodiment, the server can get a functional key sk_{ƒ} that is associated with a function ƒ from the user. Using this functional key, the server can learn the value of ƒ(x), in which x represents the driving trajectories. The function ƒ is used to learn on the trajectories. However, as noted, the server can learn nothing else about the plaintexts of the trajectories x. From this perspective, the server can make decisions according to ƒ(x), over the encrypted trajectories, without breaching the user's privacy. Consequently, when functional encryption is used in connection with machine learning, data can be uploaded to the cloud, and detections and predictions can be received from the cloud without concern over privacy and confidentiality issues.

More particularly, functional encryption works as follows. Functional encryption uses a functional key, and with the functional key, the receiver (e.g., a map app server) can gain a function value of sender's plaintexts, but nothing else. First, given a secure parameter k, the process is setup by generating public parameters pp and a master secret key msk.

$$pp , msk ← FE . setup ( {1}^{λ} )$$

Features are extracted from the data or message as follows:

$$f = σ ( X , z )$$

wherein X are features such as location, speed, velocity, time, heading angle and weather.

A functional key ƒsk is generated for an input function ƒ using the master secret key msk.

$$fsk ← FE . keygen ( msk , f )$$

A message or data x is encrypted with the public key pp into ciphertext c.

$$c ← FE . Enc ( pp , x )$$

Thereafter, the ciphertext c is decrypted using the functional key ƒsk.

Multi-input and multi-client functional encryption schemes are much closer to practical applications, in which the function ƒ can operate on several inputs x₁, x₂, . . . xₛ that may come from different clients. Informally, multi-input functional encryption can generate the functional key sk_{ƒ} associated with a n-array function ƒ, and this means that the functional key sk_{ƒ} can decrypt several ciphertexts from different clients and determine the values of ƒ(x₁, x₂, . . . , xₛ).

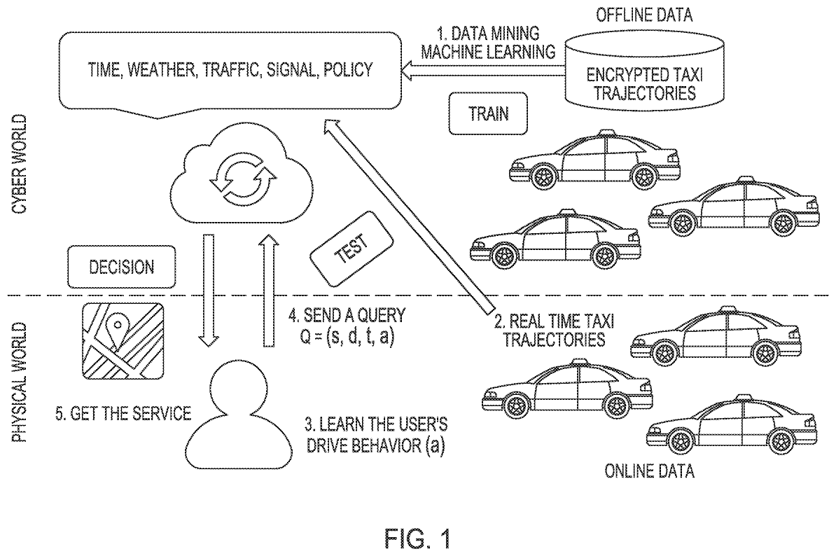

In an embodiment, as illustrated in FIG. 1, a multi-client functional encryption scheme is used for privacy-preserving machine learning. As an example, a driving direction service based on taxi GPS trajectories is considered to illustrate a functional encryption scheme for machine learning. In the cloud-based driving direction service system of FIG. 1, GPS-equipped taxis are employed as mobile sensors, reflecting the real-time traffic conditions.

However, due to the concern over privacy, drivers' trajectories have been encrypted before reporting to the cloud. To provide direction service, the cloud or server mines knowledge from the encrypted trajectories from target taxis, and this knowledge is integrated with some other conditions such as distance, weather, day types (workday or weekend), driving policies and habits, and traffic signals to train the machine learning algorithm. The taxi trajectories are extracted as training data. The training stage is offline, and usually occurs periodically, such as monthly. In the training stage, the server will learn features of the taxis' trajectories.

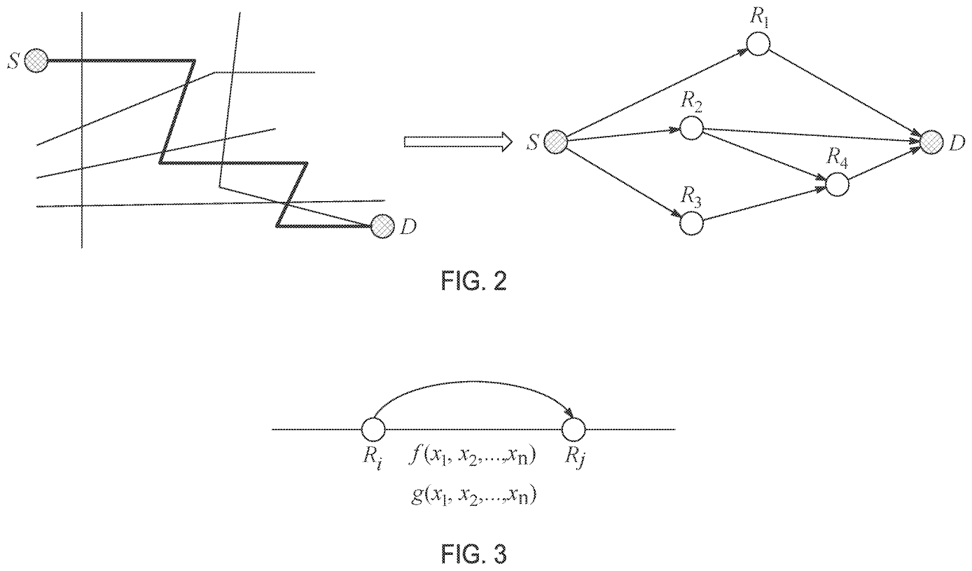

A GPS taxi trajectory is a sequence of points, containing several routes. See FIG. 2, which illustrates how to abstract a route decision into a problem to be solved so that the best directions from the start point to the destination may be determined. The directions may provide the shortest route or the quickest route (which may involve more distance than the shortest route but still be quicker).

A route is a path from a start point to an end point passing through some intermediate points. A road segment means a road from one point to the next. For every segment, considering all the prerequisite features (distance, weather, signal, traffic, day types, policy, etc.), the machine model extracts a judgement function ƒ over the features. When this segment is included in a route, it means that its judgement value suffices a taxi driver's requirement.

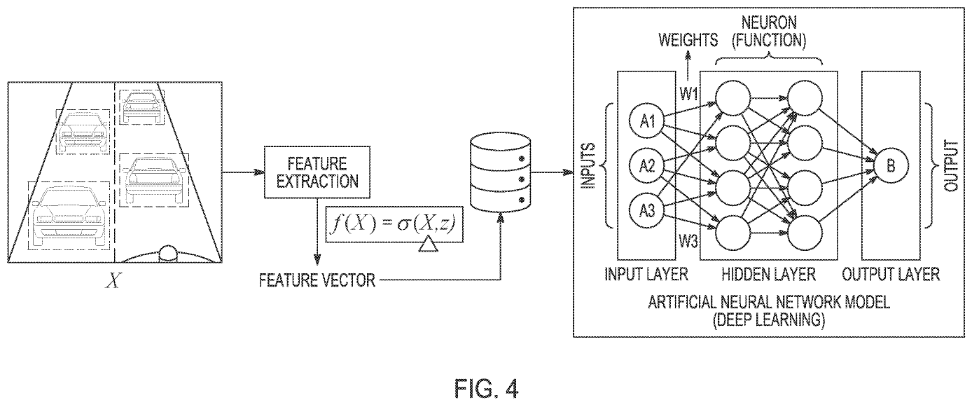

As illustrated in FIG. 3, to decide a direction, there are many factors to be considered. The useful features need to be extracted from the trajectories. Therefore, as noted above, some feature extraction functions will be employed on those encrypted trajectories to gain features of the trajectories. According to the feature extraction function values, a label will be made and attached to the road segment, the labeled road segments will be the training dataset for the machine learning model.

When the training stage is completed, the machine learning model can start the testing stage, which generates predictions or decisions. A GPS-enabled end user sends a query Q(s,d,t,α) to the cloud (FIG. 1). The query includes a start location s, a destination d, a departure time t and customized driving behavior α. The departure time can be a current time or a future time. The cloud gradually learns the driver's behavior. In this system, the taxis send real-time trajectories to the cloud, and the frequency can be as high as a minute or even less. In the testing stage, the cloud extracts real-time features from real-time encrypted trajectories, together with some other conditions (weather, day types, traffic, signals, policies, etc.).

Then, according to these features, the cloud can predict the future traffic conditions and decide a direction for the user. With the intelligence of real-time taxi drivers, there will be one or more recommendations provided. More than one recommendation can be provided because from the end users' start location to their destination, some taxi drivers may prefer one route, while other taxi drivers may prefer another route. The cloud collects the real-time encrypted data to extract real-time features and make predictions and decisions over the features.

As can be seen in FIG. 3, each road segment will produce features. To decide a direction for the user, the cloud must make decisions based on the results of feature extraction functions (ƒ(x₁ . . . xₙ), g(y₁, . . . y₁)) over the road segments. According to the decisions for every possible segment, the machine integrates a route as a direction recommendation for the end user.

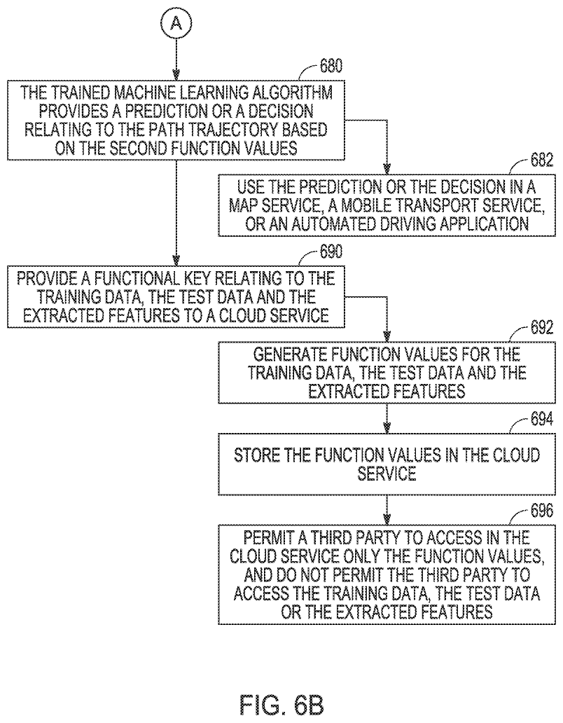

FIG. 6 is a block diagram illustrating example embodiments of operations and features of a system and method for using functional encryption in determining path trajectories such that users′ private data are protected. FIG. 6 includes a number of process and feature blocks 610-696. Though arranged substantially serially in the example of FIG. 6, other examples may reorder the blocks, omit one or more blocks, and/or execute two or more blocks in parallel using multiple processors or a single processor organized as two or more virtual machines or sub-processors.

Referring now specifically to FIG. 6, at 610, training data relating to a path trajectory are received into the system. As indicated at 612, the training data can originate from a plurality of parties or sources. At 620, the training data are functionally encrypted. As noted throughout this disclosure, this functional encryption creates first function values that comprise no private user data.

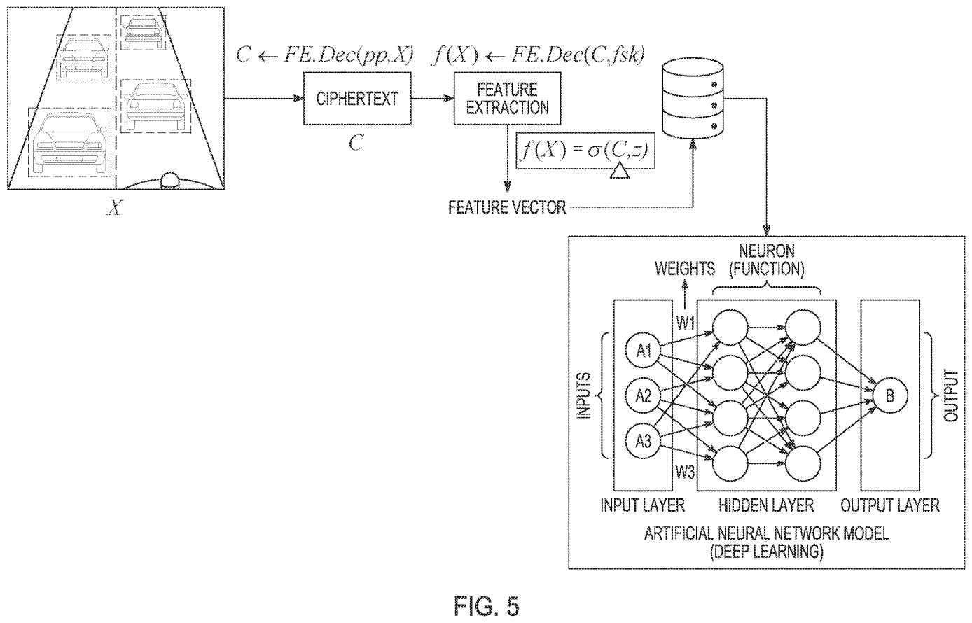

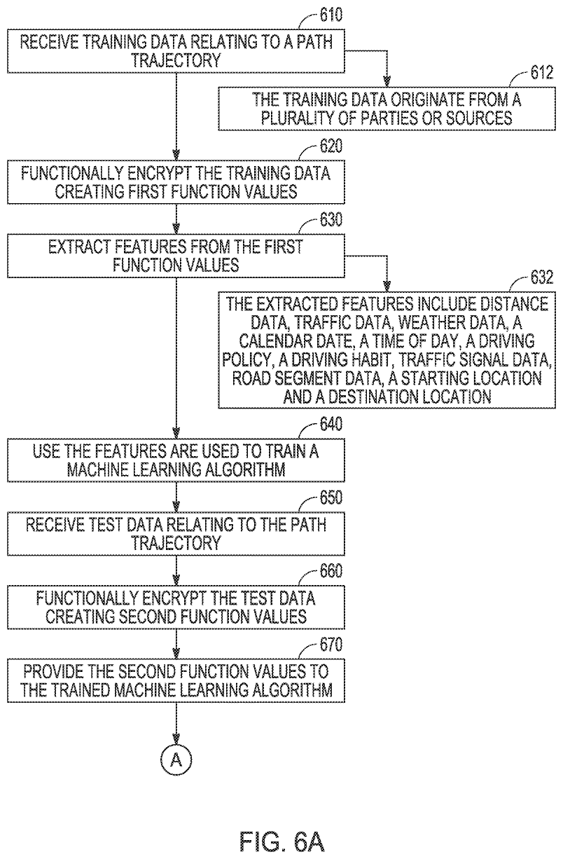

At 630, features are extracted from the first function values. The extracted features can include distance data, traffic data, weather data, a calendar date, a time of day, a driving policy, a driving habit, traffic signal data, road segment data, a starting location and a destination location (632). At 640, the features are used to train a machine learning algorithm. The manner of the feature extraction and the training of the machine learning algorithm differs from prior methods. For example, FIG. 4 illustrates a traditional approach to using deep learning in a path trajectory. Specifically, features are extracted from the data, those features are stored in a vector, and the vector is used to train an artificial neural network. FIG. 5 illustrates an embodiment of the present disclosure, wherein the data are first functionally encrypted, then features are extracted and stored in a vector, and then the functionally encrypted data in the vector are used to train the artificial neural network.

After the machine learning algorithm is trained, at 650, test data relating to the path trajectory are received. At 660, the test data is functionally encrypted. Like with the training data, the functional encryption creates second function values that comprises no private user data. At 670, the second function values are provided to the trained machine learning algorithm, and at 680, a prediction or a decision relating to the path trajectory is provided by the trained machine learning algorithm based on the second function values. As indicated at 682, the prediction or the decision can be used in a map service, a mobile transport service, or an automated driving application

In another embodiment, as indicated at 690, a functional key relating to the training data, the test data and the extracted features is provided to a cloud service. At 692, function values are generated for the training data, the test data and the extracted features. At 694, the function values are stored in the cloud service, and at 696, and a third party is permitted to access in the cloud service only the function values. The third party is not permitted to access the training data, the test data or the extracted features.

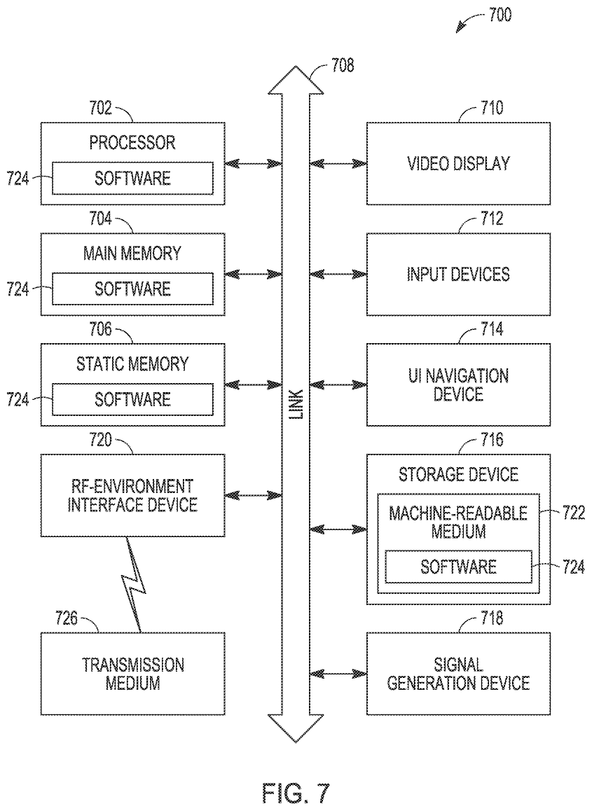

FIG. 7 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a display unit 710, an alphanumeric input device 712 (e.g., a keyboard), and a user interface (UI) navigation device 714 (e.g., a mouse). In one embodiment, the display, input device and cursor control device are a touch screen display. The computer system 700 may additionally include a storage device 716 (e.g., drive unit), a signal generation device 718 (e.g., a speaker), and a network interface device 720.

The drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 724 may further be transmitted or received over a communications network 726 using a transmission medium via the network interface device 720 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process to predict or decide a path trajectory comprising receiving training data relating to the path trajectory; functionally encrypting the training data, thereby creating first function values that comprise no private user data: extracting features from the first function values; using the features to train a machine learning algorithm; receiving test data relating to the path trajectory: functionally encrypting the test data, thereby creating second function values that comprises no private user data; providing the second function values to the trained machine learning algorithm; and receiving a prediction or a decision relating to the path trajectory from the trained machine learning algorithm based on the second function values.

Example No. 2 includes all the features of Example No. 1, and optionally includes a process wherein the extracted features comprise one or more of distance data, traffic data, weather data, a calendar date, a time of day, a driving policy, a driving habit, traffic signal data, road segment data, a starting location and a destination location.

Example No. 3 includes all the features of Example Nos. 1-2, and optionally includes a process comprising providing a functional key relating to the training data, the test data and the extracted features to a cloud service; generating function values for the training data, the test data and the extracted features; storing the function values in the cloud service; and permitting a third party to access in the cloud service only the function values and not permitting the third party to access the training data, the test data or the extracted features.

Example No. 4 includes all the features of Example Nos. 1-3, and optionally includes a process comprising using the prediction or the decision in a map service, a mobile transport service, or an automated driving application.

Example No. 5 includes all the features of Example Nos. 1-4, and optionally includes a process wherein the training data originate from a plurality of parties or sources.

Example No. 6 is a non-transitory machine-readable medium comprising instructions that when executed by a processor execute a process comprising receiving training data relating to the path trajectory: functionally encrypting the training data, thereby creating first function values that comprise no private user data; extracting features from the first function values: using the features to train a machine learning algorithm; receiving test data relating to the path trajectory; functionally encrypting the test data, thereby creating second function values that comprises no private user data; providing the second function values to the trained machine learning algorithm; and receiving a prediction or a decision relating to the path trajectory from the trained machine learning algorithm based on the second function values.

Example No. 7 includes all the features of Example No. 6, and optionally includes a non-transitory machine-readable medium wherein the extracted features comprise one or more of distance data, traffic data, weather data, a calendar date, a time of day, a driving policy, a driving habit, traffic signal data, road segment data, a starting location and a destination location.

Example No. 8 includes all the features of Example Nos. 6-7, and optionally includes a non-transitory machine-readable medium comprising instructions for providing a functional key relating to the training data, the test data and the extracted features to a cloud service: generating function values for the training data, the test data and the extracted features: storing the function values in the cloud service; and permitting a third party to access in the cloud service only the function values and not permitting the third party to access the training data, the test data or the extracted features.

Example No. 9 includes all the features of Example Nos. 6-8, and optionally includes a non-transitory machine-readable medium comprising instructions for using the prediction or the decision in a map service, a mobile transport service, or an automated driving application.

Example No. 10 includes all the features of Example Nos. 6-9, and optionally includes a non-transitory machine-readable medium wherein the training data originate from a plurality of parties or sources.

Example No. 11 is a system comprising a computer processor; and a computer memory coupled to the computer processor; wherein the computer processor and the computer memory are operable for receiving training data relating to the path trajectory; functionally encrypting the training data, thereby creating first function values that comprise no private user data; extracting features from the first function values; using the features to train a machine learning algorithm; receiving test data relating to the path trajectory; functionally encrypting the test data, thereby creating second function values that comprises no private user data; providing the second function values to the trained machine learning algorithm; and receiving a prediction or a decision relating to the path trajectory from the trained machine learning algorithm based on the second function values.

Example No. 12 includes all the features of Example No. 11, and optionally includes a system wherein the extracted features comprise one or more of distance data, traffic data, weather data, a calendar date, a time of day, a driving policy, a driving habit, traffic signal data, road segment data, a starting location and a destination location.

Example No. 13 includes all the features of Example Nos. 10-12, and optionally includes a system wherein the computer processor and the computer memory are operable for providing a functional key relating to the training data, the test data and the extracted features to a cloud service; generating function values for the training data, the test data and the extracted features; storing the function values in the cloud service; and permitting a third party to access in the cloud service only the function values and not permitting the third party to access the training data, the test data or the extracted features.

Example No. 14 includes all the features of Example Nos. 10-13, and optionally includes a system wherein the computer processor and the computer memory are operable for using the prediction or the decision in a map service, a mobile transport service, or an automated driving application.

Example No. 15 includes all the features of Example Nos. 10-14, and optionally includes a system wherein the training data originate from a plurality of parties or sources.

1. A process to predict or decide a path trajectory comprising:
receiving training data relating to the path trajectory;
functionally encrypting the training data, thereby creating first function values that comprise no private user data;
extracting features from the first function values;
using the features to train a machine learning algorithm;
receiving test data relating to the path trajectory;
functionally encrypting the test data, thereby creating second function values that comprises no private user data;
providing the second function values to the trained machine learning algorithm; and
receiving a prediction or a decision relating to the path trajectory from the trained machine learning algorithm based on the second function values.

2. The process of claim 1, wherein the extracted features comprise one or more of distance data, traffic data, weather data, a calendar date, a time of day, a driving policy, a driving habit, traffic signal data, road segment data, a starting location and a destination location.

3. The process of claim 1, comprising:
providing a functional key relating to the training data, the test data and the extracted features to a cloud service;
generating function values for the training data, the test data and the extracted features;
storing the function values in the cloud service; and
permitting a third party to access in the cloud service only the function values and not permitting the third party to access the training data, the test data or the extracted features.

4. The process of claim 1, comprising using the prediction or the decision in a map service, a mobile transport service, or an automated driving application.

5. The process of claim 1, wherein the training data originate from a plurality of parties or sources.

6. A non-transitory machine-readable medium comprising instructions that when executed by a processor execute a process to predict or decide a path trajectory comprising:
receiving training data relating to the path trajectory;
functionally encrypting the training data, thereby creating first function values that comprise no private user data;
extracting features from the first function values;
using the features to train a machine learning algorithm;
receiving test data relating to the path trajectory;
functionally encrypting the test data, thereby creating second function values that comprises no private user data;
providing the second function values to the trained machine learning algorithm; and
receiving a prediction or a decision relating to the path trajectory from the trained machine learning algorithm based on the second function values.

7. The non-transitory machine-readable medium of claim 6, wherein the extracted features comprise one or more of distance data, traffic data, weather data, a calendar date, a time of day, a driving policy, a driving habit, traffic signal data, road segment data, a starting location and a destination location.

8. The non-transitory machine-readable medium of claim 6, comprising instructions for:
providing a functional key relating to the training data, the test data and the extracted features to a cloud service:
generating function values for the training data, the test data and the extracted features:
storing the function values in the cloud service; and
permitting a third party to access in the cloud service only the function values and not permitting the third party to access the training data, the test data or the extracted features.

9. The non-transitory machine-readable medium of claim 6, comprising instructions for using the prediction or the decision in a map service, a mobile transport service, or an automated driving application.

10. The non-transitory machine-readable medium of claim 6, wherein the training data originate from a plurality of parties or sources.

11. A system comprising:
a computer processor; and
a computer memory coupled to the computer processor;
wherein the computer processor and the computer memory are operable for predicting or deciding a path trajectory by:
receiving training data relating to the path trajectory;
functionally encrypting the training data, thereby creating first function values that comprise no private user data;
extracting features from the first function values;
using the features to train a machine learning algorithm;
receiving test data relating to the path trajectory;
functionally encrypting the test data, thereby creating second function values that comprises no private user data;
providing the second function values to the trained machine learning algorithm; and
receiving a prediction or a decision relating to the path trajectory from the trained machine learning algorithm based on the second function values.

12. The system of claim 11, wherein the extracted features comprise one or more of distance data, traffic data, weather data, a calendar date, a time of day, a driving policy, a driving habit, traffic signal data, road segment data, a starting location and a destination location.

13. The system of claim 11, wherein the computer processor and the computer memory are operable for:
providing a functional key relating to the training data, the test data and the extracted features to a cloud service;
generating function values for the training data, the test data and the extracted features;
storing the function values in the cloud service; and
permitting a third party to access in the cloud service only the function values and not permitting the third party to access the training data, the test data or the extracted features.

14. The system of claim 11, wherein the computer processor and the computer memory are operable for using the prediction or the decision in a map service, a mobile transport service, or an automated driving application.

15. The system of claim 11, wherein the training data originate from a plurality of parties or sources.
